(19) United States
(12) Patent Application Publication
(10) Pub. No.: US 2023/0315733 A1
(43) Pub. Date: Oct. 5, 2023

(54) PRE-CHECKING METHOD AND PRE-CHECKING SYSTEM BASED ON THE OLAP PRE-CALCULATION MODEL

(71) Applicant: Shanghai Kyligence Information Technology Co., Ltd, Pudong District, Shanghai (CN)

(72) Inventors: Dong LI, Pudong District, Shanghai (CN); Shengping LIAO, Pudong District, Shanghai (CN); Yang LI, Pudong District, Shanghai (CN); Qing HAN, Pudong District, Shanghai (CN)

(21) Appl. No.: 15/766,820

(22) PCT Filed: Jan. 19, 2018
(86) PCT No.: PCT/CN2018/073319

§ 371 Date: May 8, 2023

(30) Foreign Application Priority Data
Dec. 29, 2017 (CN) 201711479602.X

(51) Int. Cl. G06F 16/2455; G06F 16/2453

(52) U.S. Cl. CPC G06F 16/2455; G06F 16/24542

(57) ABSTRACT

The pre-checking method and a pre-checking system based on the OLAP pre-calculation model includes: acquiring a target query statement; querying for a model matching the target query statement in preset N query models one by one, and collecting a query log at the same time; performing analysis on the query log, and judging whether a matching model exists among the N query models according to the result of analysis; and, if no matching model exists, determining modification information for modifying the pre-selected model according to the result of analysis, the target query statement, and the data model set by the user. The pre-checking system includes an acquisition module, a query engine, and a query checking module. Whether a matching model exists can be ascertained timely by performing a pre-query in N models in advance. Thus, it is unnecessary to build models and perform query check repeatedly.

### TECHNICAL FIELD

The present invention belongs to the OLAP pre-calculation information field, and particularly relates to a pre-checking method and a pre-checking system based on the OLAP pre-calculation model.

### BACKGROUND

A post-feedback process of the OLAP pre-calculation model is to judge whether the built model meet the requirements according to a business query result after the model is built, improve the design of the existing model by analyzing the result or intermediate process log, and then build the model again by repeat the above-mentioned procedures, so that correct results can be obtained for all business queries in the built model. However, a maximum limitation of the post-feedback of existing the OLAP) pre-calculation model lies in: whether the design of the model meets the query requirements can’t be pre-judged on the basis of prior knowledge (i.e., existing business query requirements) before the model is built. As a result, the model building and query checking process may have to be repeated, resulting in severe waste of time and storage cost. In the query checking process, experts have to make efforts to locate the problems and provide a model modification method. All those procedures cause increased cost of use of the model.

### SUMMARY

The technical problem to be solved in the present invention is: Owing to the fact that it is unable to pre-judge whether the existing model meets the query in the prior art, model building and query checking have to be executed repeatedly, and consequently a great deal of time and storage cost are wasted due to repeated model building.

To solve the technical problem described above, the present invention provides a preverify method based on the OLAP pre-calculation model, which comprises:
S1. acquiring a target query statement;
S2. querying for a model matching the target query statement in preset N query models one by one, and collecting a query log corresponding to the target query statement in the querying process at the same time, where, N is an integer greater than or equal to 1;
S3. performing analysis on the query log, and judging whether a matching model exists among the N query models according to the result of analysis;
S4. if no matching model exists, determining modification information for modifying the pre-selected model according to the result of analysis, the target query statement, and the data model set by the user, so that the modified pre-selected model matches the target query statement.

The present invention has the following beneficial effects: whether a matching model exists can be ascertained timely by performing a pre-query in N models, i.e., performing a query in N models one by one according to the target query statement; if no matching model exists, modification proposals can be fed back to modify the model; thus, whether a model that meets the query requirements among N models can be pre-judged, without performing model building and query checking repeatedly, and thereby the time and storage cost are reduced greatly.

Furthermore, if the target query statement is a complex statement composed of a plurality of sub-query statements, the step S2 specifically comprises:
querying for a model matching each sub-query statement in the N query models one by one, and collecting a plurality of query logs corresponding to the plurality of sub-query statements respectively in the query process at the same time;
the step S3 specifically comprises:
   performing analysis on the plurality of query logs respectively, and judging whether a model matching each of the sub-query statements exists among the N query models according to a plurality of results of analysis;
the step S4 specifically comprises:
   and, if a model matching each of the sub-query statements exists, mark the model as the pre-selected model.

The above steps attain the following beneficial effects: if the target query statement is a complex statement composed of a plurality of sub-query statements, the target query statement may be split into a plurality of sub-query statements, and queries may be performed according to those sub-query statements one by one. If there is a model matching all of those sub-query statements, it indicates that a matching model exists among the N models; in that case, the matching model is marked as the pre-selected model. In that way, the model checking time and cost can be reduced greatly; at the same time, the accuracy of query can be improved greatly by querying with a plurality of sub-query statements.

Furthermore, the step of querying for a model matching the target query statement in preset N query models one by one comprises:

querying for a model matching the target query statement in preset N query models one by one according to a relationship between tables used by the target query statement and logical tables predefined in the preset N query models and a relationship between dimensions used by the target query statement and dimensions predefined in the preset N query models.

Furthermore, the step of querying for a model matching each of the sub-query statements in the N query models one by one comprises:

querying for a model matching each of the sub-query statements in the preset N query models one by one according to a relationship between tables used by each sub-query statement and logical tables predefined in the preset N query models and a relationship between dimensions used by each sub-target query statement and dimensions predefined in the preset N query models.

Furthermore, in the step S4, the operation of determining modification information for the matching model according to the result of analysis, the target query statement, and the data model set by the user so as to modify the pre-selected model according to the modification information comprises:

determining tables, measurements, and dimensions of the matching model according to the result of analysis, the target query statement, and the data model set by the user, and adding the tables, measurements, and dimensions of the matching model to the pre-selected model.

The above steps attain the following beneficial effects: tables, measurements and dimensions of the matching model can be ascertained according to the result of analysis of query log. Thus, a matching model can be obtained by modifying the model according to the requirements, and thereby the required time and cost can be reduced greatly.

The present invention further relates to a pre-checking system based on the OLAP pre-calculation model, which comprises: an acquisition module, a query engine, and a query checking module; wherein,
the acquisition module is configured to acquire a target query statement;
the query engine is configured to query for a model matching the target query statement in preset N query models one by one, and collect a query log corresponding to the target query statement in the query process at the same time, where, N is an integer greater than or equal to 1;
the query checking module is configured to perform analysis on the query log, and judge whether a matching model exists among the N query models according to the result of analysis; and, if no matching model exists, determine modification information for modifying the pre-selected model according to the result of analysis, the target query statement, and the data model set by the user, so that the modified pre-selected model matches the target query statement.

The present invention has the following beneficial effects: whether a matching model exists can be ascertained timely by performing a pre-query in N models, i.e., performing a query in N models one by one according to the target query statement; if no matching model exists, modification proposals can be fed back to modify the model; thus, whether a model that meets the query requirements among N models can be pre-judged, without performing model building and query checking repeatedly, and thereby the time and storage cost are reduced greatly.

Furthermore, if the target query statement is a complex statement composed of a plurality of sub-query statements, the query engine is further configured to query for a model matching each of the sub-query statements in the N query models one by one, and collect a plurality of query logs corresponding to the plurality of sub-query statements respectively in the query process at the same time.

Furthermore, the query engine is further configured to perform analysis on the plurality of query logs respectively, and judge whether a model matching each of the sub-query statements exists among the N query models according to a plurality of results of analysis;

and, if a model matching each of the sub-query statements exists, mark the model as the pre-selected model.

The above steps attain the following beneficial effects: if the target query statement is a complex statement composed of a plurality of sub-query statements, the target query statement may be split into a plurality of sub-query statements, and queries may be performed according to those sub-query statements one by one. If there is a model matching all of those sub-query statements, it indicates that a matching model exists among the N models; in that case, the matching model is marked as the pre-selected model In that way, the model checking time and cost can be reduced greatly; at the same time, the accuracy of query can be improved greatly by querying with a plurality of sub-query statements.

Furthermore, the query engine is specifically configured to query for a model matching the target query statement in preset N query models one by one according to a relationship between tables used by the target query statement and logical tables predefined in the preset N query models and a relationship between dimensions used by the target query statement and dimensions predefined in the preset N query models.

Furthermore, the query checking module is specifically configured to determine tables, measurements, and dimensions of the matching model according to the result of analysis, the target query statement, and the data model set by the user, and adding the tables, measurements, and dimensions of the matching model to the pre-selected model.

The above steps attain the following beneficial effects: tables, measurements and dimensions of the matching model can be ascertained according to the result of analysis of query log. Thus, a matching model can be obtained by modifying the model according to the requirements, and thereby the required time and cost can be reduced greatly.

### BRIEF DESCRIPTION OF THE DRAWINGS

FIG. 1 is a flow chart of the pre-checking method based on the OLAP pre-calculation model according to the present invention,

FIG. 2 is a schematic diagram of the pre-checking system based on the OLAP pre-calculation model according to the present invention.

### DETAILED DESCRIPTION OF THE EMBODIMENTS

Hereunder the principle and features of the present invention will be detailed with reference to the accompanying drawings. However, it should be noted that the embodiments are provided only to interpret the present invention but don’t constitute any limitation to the scope of the present invention.

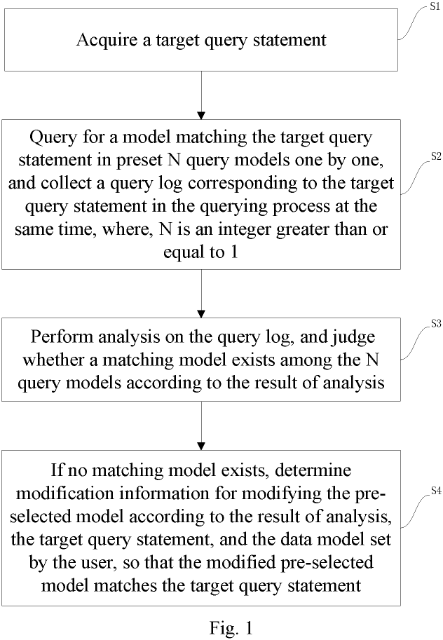

As shown in FIG. 1, a pre-checking method based on the OLAP pre-calculation model is provided in an embodiment 1 of the present invention, comprising:
S1. acquiring a target query statement;
S2. querying for a model matching the target query statement in preset N query models one by one, and collecting a query log corresponding to the target query statement in the querying process at the same time, where, N is an integer greater than or equal to 1;
S3. performing analysis on the query log, and judging whether a matching model exists among the N query models according to the result of analysis;
S4. if no matching model exists, determining modification information for modifying the pre-selected model according to the result of analysis, the target query statement, and the data model set by the user, so that the modified pre-selected model matches the target query statement.

It can be understood: in the embodiment 1, first, a SQL parser analyzes the target query statement (i.e., a SQL statement) inputted by the user and judges the logical structure of the target query statement; at the same time, a model matching the target query statement is queried for in preset N query models according to the target query statement, and a query log corresponding to the target query statement is collected in the query process, where, N is an integer greater than or equal to 1.

In the embodiment 1, whether a matching model exists can be ascertained timely by performing a pre-query in N models, i.e., performing a query in N models one by one according to the target query statement; if no matching model exists, modification proposals can be fed back to modify the model; thus, whether a model that meets the query requirements among N models can be pre-judged, without performing model building and query checking repeatedly, and thereby the time and storage cost are reduced greatly.

Optionally, in an embodiment 2, if the target query statement is a complex statement compose of a plurality of sub-query statements, the step S2. specifically comprises:
querying for a model matching each sub-query statement in the N query models one by one, and collecting a plurality of query logs corresponding to the plurality of sub-query statements respectively in the query process at the same time;
the step S3 specifically comprises:
   performing analysis on the plurality of query logs respectively, and judging whether a model matching each of the sub-query statements exists among the N query models according to a plurality of results of analysis;
the step S4 specifically comprises:
   if a model matching each of the sub-query statements exists, marking the model as the pre-selected model.

It can be understood: in the embodiment 2, if the target query statement is a complex statement composed of a plurality of sub-query statements, queries may be performed in the N query models one by one with the plurality of query statements respectively to find out a model matching each of the sub-query statements; at the same time, a plurality of query logs corresponding to the plurality of sub-query statements respectively are collected in the query process; for example, a query may be performed in the N query models with each sub-query statement, and then filtering may be executed after queries are performed with all of the sub-query statements. For example, ten matching models are found after a query is performed with the first sub-query statement; seven matching models are found after a query with the second sub-query statement; four matching models are found after a query with the third sub-query statement; then, the matching models obtained with the three sub-query statements are filtered to obtain one or two models matching each of the three sub-query statements. In that case, it indicates that one or more models matching the target query statement exist among the N models, i.e., one or more matching models exist among the N models. Thus, it can be ascertained that the model selected by the user among the N models supports query with the target query statement.

Optionally, in an embodiment 3, the step of querying for a model matching the target query statement in preset N query models one by one comprises:

querying for a model matching the target query statement in preset N query models one by one according to a relationship between tables used by the target query statement and logical tables predefined in the preset N query models and a relationship between dimensions used by the target query statement and dimensions predefined in the preset N query models.

It can be understood: in the embodiment 3, queries are performed according to the relationship between tables used by the target query statement and tables used by each model, as well as the relationship between dimensions used by the target query statement and dimensions used by each model; thus, models matching the target query statements can be found out one by one.

Optionally, in an embodiment 4, the step of querying for a model matching each of the sub-query statements in the N query models one by one comprises:

querying for a model matching each of the sub-query statements in the preset N query models one by one according to a relationship between tables used by each sub-query statement and logical tables predefined in the preset N query models and a relationship between dimensions used by each sub-target query statement and dimensions predefined in the preset N query models.

It can be understood: the embodiment 4 provides a scheme for implementing another embodiment on the basis of the embodiment 2.

Optionally, in an embodiment 5, in the step S4, the operation of determining modification information for the matching model according to the result of analysis, the target query statement, and the data model set by the user so as to modify the pre-selected model according to the modification information comprises:

determining tables, measurements, and dimensions of the matching model according to the result of analysis, the target query statement, and the data model set by the user, and adding the tables, measurements, and dimensions of the matching model to the pre-selected model.

It can be understood: a scheme improved on the basis of the embodiment 3 is provided in the embodiment 4. In that way, the model can be modified according to the query requirements to obtain a matching model, and thereby the required time and cost can be reduced greatly.

In all of the above embodiments, the specific query process based on OLAP pre-calculation model is as follows:
Initialize success=true, reasons=[];
Traverse each sub-queries in the SQL query;
Judge whether a model is hit with the sub-query in the query log; if no model is hit, set success=false, and add the reasons for failure into “reasons”;
Judge whether “success” is true after all sub-queries are traversed; it indicates that the model supports the target query if “success” is true; otherwise it indicates that the model doesn’t support the target query;
If the model doesn’t support the target query, extract key information and present the reasons for non-support and provide proposals, by executing type matching in the “reasons” and regular matching in the detailed information.

For example, in the case that the queried column doesn’t exist, the OLAP model has defined several dimensions, and the target query SQL uses dimensions beyond the model.

In the pre-query process, the query engine matches the model according to the tables used in the SQL and the association relationship between the tables, and then compares the dimensions used in the SQL with the dimensions defined in the model one by one and finds that the target SQL uses dimensions that are not defined in the model. In that case, the query engine returns a “false” result, and the log information collected in the log is “[column 1, column 2, ..., column n] are not found in the model”; thus, the model recommends that the module should parse the type of the error, and provides the following proposal: add [column 1, column 2, ..., column n] as dimensions into the model.

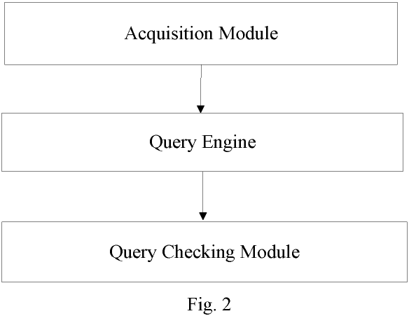

As shown in FIG. 2, in an embodiment 6, the present invention relates to a pre-checking system based on the OLAP pre-calculation model, which comprises: an acquisition module, a query engine, and a query checking module; wherein,
the acquisition module is configured to acquire a target query statement;
the query engine is configured to query for a model matching the target query statement in preset N query models one by one, and collect a query log corresponding to the target query statement in the query process at the same time, where, N is an integer greater than or equal to 1;
the query checking module is configured to perform analysis on the query log, and judge whether a matching model exists among the N query models according to the result of analysis; and, if no matching model exists, determine modification information for modifying the pre-selected model according to the result of analysis, the target query statement, and the data model set by the user, so that the modified pre-selected model matches the target query statement.

It can be understood: in the embodiment 6, first, a SQL parser analyzes the target query statement (i.e., a SQL statement) inputted by the user and judges the logical structure of the target query statement; at the same time, a model matching the target query statement is queried for in preset N query models according to the target query statement, and a query log corresponding to the target query statement is collected in the query process, where, N is an integer greater than or equal to 1.

In the embodiment 6, whether a matching model exists can be ascertained timely by performing a pre-query in N models, i.e., performing a query in N models one by one according to the target query statement; if no matching model exists, modification proposals can be fed back to modify the model; thus, whether a model that meets the query requirements among N models can be pre-judged, without performing model building and query checking repeatedly, and thereby the time and storage cost are reduced greatly.

Optionally, in an embodiment 7, if the target query statement is a complex statement composed of a plurality of sub-query statements, the query engine is further configured to query for a model matching each of the sub-query statements in the N query models one by one, and collect a plurality of query logs corresponding to the plurality of sub-query statements respectively in the query process at the same time.

It can be understood: the embodiment 7 provides a scheme for implementing another embodiment on the basis of the embodiment 6.

Optionally, in an embodiment 8, the query engine is further configured to perform analysis on the plurality of query logs respectively, and judge whether a model matching each of the sub-query statements exists among the N query models according to a plurality of results of analysis;

and, if a model matching each of the sub-query statements exists, mark the model as the pre-selected model.

It can be understood: the embodiment 8 provides a scheme for implementing another embodiment on the basis of the embodiment 7. In the embodiment 8, if the target query statement is a complex statement composed of a plurality of sub-query statements, queries may be performed in the N query models one by one with the plurality of query statements respectively to find out a model matching each of the sub-query statements; at the same time, a plurality of query logs corresponding to the plurality of sub-query statements respectively are collected in the query process; for example, a query may be performed in the N query models with each sub-query statement, and then filtering may be executed after queries are performed with all of the sub-query statements. For example, ten matching models are found after a query is performed with the first sub-query statement; seven matching models are found after a query with the second sub-query statement; four matching models are found after a query with the third sub-query statement; then, the matching models obtained with the three sub-query statements are filtered to obtain one or two models matching each of the three sub-query statements. In that case, it indicates that one or more models matching the target query statement exist among the N models, i.e., one or more matching models exist among the N models. Thus, it can be ascertained that the model selected by the user among the N models supports query with the target query statement.

In the embodiment 8, if the target query statement is a complex statement composed of a plurality of sub-query statements, the target query statement may be split into a plurality of sub-query statements, and queries may be performed according to those sub-query statements one by one. If there is a model matching all of those sub-query statements, it indicates that a matching model exists among the N models, in that case, the matching model is marked as the pre-selected model. In that way, the model checking time and cost can be reduced greatly; at the same time, the accuracy of query can be improved greatly by querying with a plurality of sub-query statements.

Optionally, in an embodiment 9, the query engine is specifically configured to query for a model matching the target query statement in preset N query models one by one according to a relationship between tables used by the target query statement and logical tables predefined in the preset N query models and a relationship between dimensions used by the target query statement and dimensions predefined in the preset N query models.

It can be understood: the embodiment 9 provides a scheme for implementing another embodiment on the basis of the embodiments 6, 7 or 8. In the embodiment 9, queries are performed according to the relationship between tables used by the target query statement and tables used by each model, as well as the relationship between dimensions used by the target query statement and dimensions used by each model; thus, models matching the target query statements can be found out one by one.

Optionally, in an embodiment 10, the query checking module is specifically configured to determine tables, measurements, and dimensions of the matching model according to the result of analysis, the target query statement, and the data model set by the user, and adding the tables, measurements, and dimensions of the matching model to the pre-selected model.

It can be understood: The embodiment 10 provides a scheme for implementing another embodiment on the basis of the embodiment 9. A scheme improved on the basis of the embodiment 3 is provided in the embodiment 4. Thus, the model can be modified according to the query requirements to obtain a matching model, and thereby the required time and cost can be reduced greatly.

In all of the above embodiments, the specific query process based on the OLAP pre-calculation model is as follows:
Initialize success=true, reasons=[];
Traverse each sub-queries in the SQL query;
Judge whether a model is hit with the sub-query in the query log; if no model is hit, set success=false, and add the reasons for failure into “reasons”;
Judge whether “success” is true after all sub-queries are traversed; it indicates that the model supports the target query if “success” is true; otherwise it indicates that the model doesn’t support the target query;
If the model doesn’t support the target query, extract key information and present the reasons for non-support and provide proposals, by executing type matching in the “reasons” and regular matching in the detailed information.

For example, in the case that the queried column doesn’t exist, the OLAP model has defined several dimensions, and the target query SQL uses dimensions beyond the model.

In the pre-query process, the query engine matches the model according to the tables used in the SQL and the association relationship between the tables, and then compares the dimensions used in the SQL with the dimensions defined in the model one by one and finds that the target SQL uses dimensions that are not defined in the model. In that case, the query engine returns a “false” result, and the log information collected in the log is “[column 1, column 2, ..., column n] are not found in the model”; thus, the model recommends that the module should parse the type of the error, and provides the following proposal: add [column 1, column 2, ..., column n] as dimensions into the model.

In the present specification, the exemplary expression of the above terms may not necessarily refer to the same embodiment or example. Moreover, the specific features, structures, materials, or characteristics described can be combined appropriately in any one or more embodiments or examples. Furthermore, those skilled in the art may combine or assemble different embodiments or examples and features in different embodiments or examples described herein, provided that there is no contradiction between them.

While the present invention is described above in some preferred embodiments, the present invention is not limited to those preferred embodiments. Any modification, equivalent replacement, and improvement made without departing from the spirit and principle of the present invention shall be deemed as falling into the scope of protection of the present invention.

We claim:

1. A pre-checking method based on the OLAP precalculation model, comprising the steps of:
S1. acquiring a target query statement;
S2. querying for a model matching the target query statement in preset N query models one by one, and collecting a query log corresponding to the target query statement in the querying process at the same time, where, N is an integer greater than or equal to 1;
S3. performing analysis on the query log, and judging whether a matching model exists among the N query models according to the result of analysis; and
S4. if no matching model exists, determining modification information for modifying the pre-selected model according to the result of analysis, the target query statement, and the data model set by the user, so that the modified pre-selected model matches the target query statement.

2. The pre-checking method according to claim 1, wherein,
if the target query statement is a complex statement comprised of a plurality of sub-query statements, the step S2 comprises the step of:
querying for a model matching each sub-query statement in the N query models one by one, and collecting a plurality of query logs corresponding to the plurality of sub-query statements respectively in the query process at the same time;
wherein the step S3 comprises the step of:
performing analysis on the plurality of query logs respectively, and judging whether a model matching each of the sub-query statements exists among the N query models according to a plurality of results of analysis;, _ and
wherein the step S4 comprises the step of:
if a model matching each of the sub-query statements exists, marking the model as the pre-selected model.

3. The pre-checking method according to claim 1,
wherein; the step of querying for a model matching the target query statement in preset N query models one by one comprises the step of:
querying for a model matching the target query statement in preset N query models one by one according to a relationship between tables used by the target query statement and logical tables predefined in the preset N query models and a relationship between dimensions used by the target query statement and dimensions predefined in the preset N query models.

4. The pre-checking method according to claim 2,
wherein, the step of querying for a model matching each of the sub-query statements in the N query models one by one comprises the step of:
querying for a model matching each of the sub-query statements in the preset N query models one by one according to a relationship between tables used by each sub-query statement and logical tables predefined in the preset N query models and a relationship between dimensions used by each sub-target query statement and dimensions predefined in the preset N query models.

5. The pre-checking method according to claim 3,
wherein, in the step S4, the operation of determining modification information for the matching model according to the result of analysis, the target query statement, and the data model set by the user so as to modify the pre-selected model according to the modification information comprises the step of:
determining tables, measurements, and dimensions of the matching model according to the result of analysis, the target query statement, and the data model set by the user, and adding the tables, measurements, and dimensions of the matching model to the pre-selected model.

6. A pre-checking system based on the OLAP precalculation model, comprising:
an acquisition module;
a query engine; and
a query checking module,
wherein-,-the acquisition module is configured to acquire a target query statement,
wherein the query engine is configured to query for a model matching the target query statement in preset N query models one by one, and collect a query log corresponding to the target query statement in the query process at the same time, where, N is an integer greater than or equal to 1, and
wherein the query checking module is configured to perform analysis on the query log, and judge whether a matching model exists among the N query models according to the result of analysis; and, if no matching model exists, determine modification information for modifying the pre-selected model according to the result of analysis, the target query statement, and the data model set by the user, so that the modified pre-selected model matches the target query statement.

7. The pre-checking system according to claim 6,
wherein, if the target query statement is a complex statement comprised of a plurality of sub-query statements, the query engine is further configured to query for a model matching each of the sub-query statements in the N query models one by one, and collect a plurality of query logs corresponding to the plurality of sub-query statements respectively in the query process at the same time.

8. The pre-checking system according to claim 7,
wherein the query engine is further configured to perform analysis on the plurality of query logs respectively, judge whether a model matching each of the sub-query statements exists among the N query models according to a plurality of results of analysis,
and, if a model matching each of the sub-query statements exists, mark the model as the pre-selected model.

9. The pre-checking system according to claim 6, wherein; the query engine is specifically configured to query for a model matching the target query statement in preset N query models one by one according to a relationship between tables used by the target query statement and logical tables predefined in the preset N query models and a relationship between dimensions used by the target query statement and dimensions predefined in the preset N query models.

10. The pre-checking system according to claim 9, wherein; the query checking module is specifically configured to determine tables, measurements, and dimensions of the matching model according to the result of analysis, the target query statement, and the data model set by the user, and adding the tables, measurements, and dimensions of the matching model to the pre-selected model.
